(19) United States
(12) Patent Application Publication
(10) Pub. No.: US 2022/0114386 A1
(43) Pub. Date: Apr. 14, 2022

(54) METHOD AND SYSTEM FOR FREQUENCY CODING IMAGE DATA

(71) Applicant: Robert Bosch GmbH, Stuttgart (DE)

(72) Inventors: Jan Bechtold, Ebringen (DE); Volker Fischer, Renningen (DE)

(21) Appl. No.: 17/447,364

(22) Filed: Sep. 10, 2021

(30) Foreign Application Priority Data
Oct. 8, 2020 (DE) 102020212716.6

(51) Int. Cl. G06K 9/62; G06T 9/00; G06N 20/00

(52) U.S. Cl. CPC G06K 9/6256; G06N 20/00; G06K 9/6267; G06T 9/00

(57) ABSTRACT

A computer-implemented method for frequency coding of image data from an imaging sensor. The method includes: supplying first image data of an individual image recorded by an imaging sensor, the first image data having depth values of the individual image coded as a whole number or as a floating-point number; receiving the first image data by an algorithm, which frequency codes the depth values of the individual image by a predefined number of periodic functions; and outputting second image data by the algorithm, the second image data having frequency coded depth values of the individual image. A computer-implemented method is described for supplying an algorithm of machine learning for the classification of objects included in image data of an individual image from an imaging sensor. A system for the frequency coding of image data from an imaging sensor, a computer program, and a computer-readable data carrier, are also described.

### CROSS REFERENCE

The present application claims the benefit under 35 U.S.C. § 119 of German Patent Application No. DE 102020212716.6 filed on Oct. 8, 2020, which is expressly incorporated herein by reference in its entirety.

### FIELD

The present invention relates to a computer-implemented method for frequency coding of images from an imaging sensor.

In addition, the invention relates to a computer-implemented method for supplying an algorithm of machine learning for the classification of objects included in image data of an individual image from an imaging sensor.

Moreover, the present invention relates to a system for frequency coding image data from an imaging sensor.

### BACKGROUND INFORMATION

Generally, image data that are processed by artificial neural networks are stored in a raster in which individual values, that is to say, pixels, include image information. This information is typically a decimal value or a floating-point value. All conventional methods such as the ResNet (residual neural network) for an image classification use such a data representation.

Depth images such as they are generated by depth cameras are processed by artificial neural networks in this representation.

In depth images, information is evaluated and near objects and distant objects have very different values. The large bandwidth of values is problematic for the artificial neural network. Even a standardization of the data does not fully resolve this problem. Small details are representable only with difficulty in this representation.

An object of the present invention is to provide an improved method and system which make it possible to represent details in depth images more optimally.

The object may be achieved by a computer-implemented method for frequency coding of image data from an imaging sensor in accordance with an example embodiment of the present invention.

In addition, the object may be achieved by a computer-implemented method for supplying an algorithm of machine learning for the classification of objects included in image data of an individual image from an imaging sensor, in accordance with an example embodiment of the present invention.

Moreover, the object may be achieved by a system for frequency coding of image data from the imaging sensor in accordance with an example embodiment of the present invention, a computer program in accordance with an example embodiment of the present invention, and a computer-readable data carrier in accordance with an example embodiment of the present invention.

### SUMMARY

The present invention provides a computer-implemented method for frequency coding of image data from an imaging sensor. In accordance with an example embodiment of the present invention, the method includes the supply of first image data of an individual image recorded by an imaging sensor, the first image data having depth values of the individual image that are coded as a whole number or a floating-point number.

The example embodiment of the present invention furthermore includes the receiving of the first image data by an algorithm which frequency-codes the depth values of the individual image by a predefined number of periodic functions. The example embodiment of the present method moreover includes an output of second image data by the algorithm, the second image data including frequency coded depth values of the individual image.

In addition, an example embodiment of the present invention provides a computer-implemented method for supplying an algorithm of machine learning for the classification of objects included in image data of an individual image from an imaging sensor.

The method in accordance with an example embodiment of the present invention includes the receiving of image data output by the algorithm according to the present invention, the image data including frequency coded depth values of the individual image.

In addition, the method in accordance with the example embodiment of the present invention includes the receiving of a classification result allocated to an object included in a respective individual image.

Moreover, an example embodiment of the present invention includes training of the algorithm of machine learning using the image data and the classification results allocated to the object included in the respective individual image, by an optimization algorithm, which calculates an extreme value of a loss function.

In addition, the present invention provides a system for frequency coding of image data from an imaging sensor. In accordance with an example embodiment of the present invention, the system includes an imaging sensor which supplies first image data of a recorded individual image, the first image data including depth values of the individual image coded as a whole number or a floating-point number.

The system furthermore includes a computing device, which is designed to carry out the method according to the present invention. In addition, the present invention provides a computer program having program code for carrying out the method according to the present invention when the computer program is executed on a computer.

In addition, the present invention provides a computer-readable data carrier having program code of a computer program in order to carry out the method according to the present invention when the computer program is executed on a computer.

One feature of the present invention is to transform the depth values into an advantageous representation in which the details included in the image data are able to be represented more precisely, this being accomplished by the frequency coding of the first image data of the individual image supplied by the imaging sensor of the vehicle.

Autonomous driving, for example, represents one possible application of the method for frequency coding of image data from an imaging sensor.

Cameras are of great importance in the context of autonomous driving because they supply a high resolution of the environment in the form of an RGB image. Neural networks are the current state of the art for an image analysis and typically operate on the raw image data, which come directly from the sensor as the three channels red, green and blue.

The color values provides little direct information about the content of the image. For this reason, neural networks are used to assign a semantic class to each image pixel (RGB). This is also known as a classification per pixel or also as segmentation.

For instance, the gray and black of asphalt is allocated to the class “street”. The dominant colors and nuances of the color characteristics have a different resolution in the RGB representation and are possibly difficult to detect by the neural network. Here, the input coding according to the present invention may be helpful to the neural network in processing the image content more easily or in perceiving nuances in the first place.

Advantageous embodiments and further refinements result from the description herein with reference to the figures.

According to one preferred further refinement of the present invention, it is provided that the predefined number of periodic functions is given by sine functions or cosine functions of a constant frequency, and that each one of the periodic functions has a frequency that is defined within a predefined spectrum and differs from the frequency of the other ones of the predefined number of periodic functions.

Instead of being represented as a floating-point number as in conventional methods, the image data of the imaging sensor, in particular the depth information, is represented by a higher number of channels in the framework of the present invention.

The transformation into multiple channels is achieved here by the use of the predefined number of periodic functions, which means, for example, that certain aspects of the image data are represented by lower frequencies and other aspects of the image data are represented by higher frequencies.

Because of the transformation of the first image data of the individual image and the use of a multiplicity of periodic functions of different frequencies, it is therefore advantageously possible to achieve a better detection or resolution of details in the image data.

According to another preferred further refinement of the present invention, it is provided that the depth value of each coordinate, in particular of each image pixel, of the input image is frequency coded by the algorithm using the predefined number of periodic functions. Because of the frequency coding of each individual image pixel, better perception of image nuances by the downstream image classifier is therefore achievable in an advantageous manner.

According to one further preferred refinement of the present invention, it is provided that each one of the periodic functions stores the depth values of the individual image in a channel that is allocated to the function. A better detection or better classification ability of objects included in image data is therefore possible inasmuch as the frequency-coded image data are shown or represented by a greater number of channels.

According to a further preferred refinement of the present invention, it is provided that the first image data of the individual image are coded in gray scales, in particular using one channel per pixel for the color information and one channel per pixel for the depth value, or as an RGB color image, in particular using three channels per pixel for the color information, possibly a further alpha channel for a transparency, and one channel per pixel for the depth value.

According to a further preferred refinement of the present invention, it is provided that the imaging sensor is embodied as a camera sensor, a lidar sensor, a radar sensor or an ultrasonic sensor.

In an advantageous manner, the method for frequency coding of image data of the imaging sensor according to the present invention is therefore suitable for use with different types of sensors.

According to a further preferred refinement of the present invention, it is provided that the algorithm is a set of all periodic functions, and the predefined number of periodic functions amounts to 10 to 50, in particular to 15 to 25.

This advantageously allows for a more optimal representation of the image data, which leads to a more precise detection and classification accuracy by a downstream artificial neural network which processes these data.

According to another preferred refinement of the present invention, it is provided that the algorithm converts the frequency coded depth values of the individual image into a vector representation. This notation advantageously allows for better processing of the data by a classifier or a regressor such as an artificial neural network.

The vector or tensor distorts the different orders of magnitude of the map or the raster of the original image. Harmful changes, which are known as adversarial attacks and are barely visible in the original image, are thereby able to be identified by the classifier or regressor.

According to a further preferred refinement of the present invention, it is provided that the second image data, which are output by the algorithm and have frequency-coded depth values of the individual image, are provided as input data for training and/or for the inference of an algorithm of machine learning, in particular of an artificial neural network, for the classification, detection and/or segmentation of objects included in the image data from the imaging sensor.

The algorithm according to the present invention thus advantageously represents a preprocessing step, which allows for better processability of the image data by an algorithm of machine learning.

The described embodiments and refinements are able to be combined with one another as desired.

Additional possible embodiments, further refinements and implementations of the present invention also include not explicitly mentioned combinations of features of the present invention described in the previous or the following text with regard to the exemplary embodiments.

### BRIEF DESCRIPTION OF THE DRAWINGS

The figures are meant to provide a better understanding of the example embodiments of the present invention. They illustrate embodiments and, in conjunction with the description, are intended to describe principles and concepts of the present invention.

Other embodiments and many of the mentioned advantages result in view of the figures. The illustrated elements of the figures are not necessarily depicted true to scale in relation to one another.

### BRIEF DESCRIPTION OF THE DRAWINGS

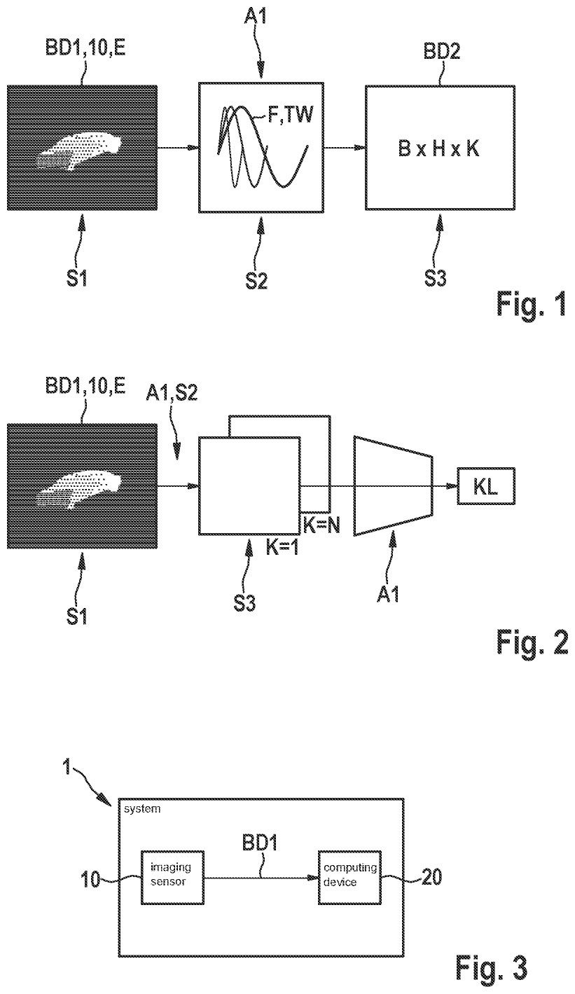

FIG. 1 shows a flow diagram of a computer-implemented method for frequency coding of image data from an imaging sensor according to a preferred embodiment of the present invention.

FIG. 2 shows a flow diagram of the computer-implemented method for frequency coding of image data from the imaging sensor according to the preferred embodiment of the present invention.

FIG. 3 shows a schematic representation of a system for frequency coding of image data from the imaging sensor according to the preferred embodiment of the present invention.

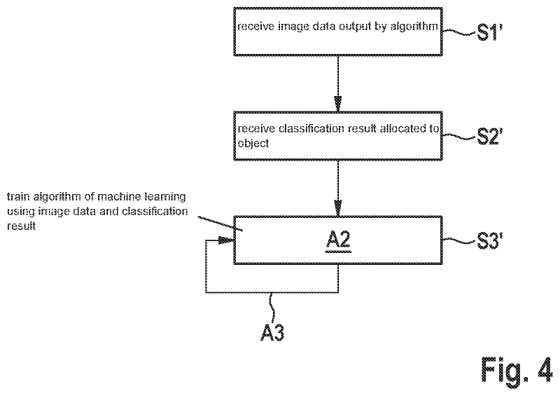

FIG. 4 shows a flow diagram of a computer-implemented method for supplying an algorithm of machine learning for the classification of objects included in image data of an individual image from an imaging sensor according to the preferred embodiment of the present invention.

### DETAILED DESCRIPTION OF EXAMPLE EMBODIMENTS

Unless stated to the contrary, matching reference numerals in the figures of the drawings refer to the same or functionally equivalent elements, parts or components.

FIG. 1 shows a flow diagram of a computer-implemented method for frequency coding of image data from an imaging sensor according to a preferred embodiment of the present invention.

The imaging sensor is preferably installed in a motor vehicle. As an alternative, the imaging sensor is able to be used in a public space, e.g., in the region of a road intersection, in order to monitor traffic. As a further alternative, the imaging sensor may be provided in a building, such as in an entry area of the building, for the purpose of monitoring the environment.

The imaging sensor preferably is an environment sensor of a motor vehicle. As an alternative, for example, the imaging sensor may be embodied as an interior sensor installed in the motor vehicle or as an environment sensor installed in a public space and/or on or in buildings.

The present method includes the supply S1 of first image data BD1 of an individual image E recorded by an imaging sensor 10, the first image data BD1 having depth values TW of individual image E coded as a whole number or as a floating-point number. In addition, the present method includes the receiving S2 of the first image data BD1 by an algorithm A1 which frequency codes depth values TW of individual image E by a predefined number of periodic functions F.

In addition, the present method includes an output S3 of second image data BD2 by algorithm A1, the second image data BD2 having frequency coded depth values TW of individual image E. Second image data BD2 have the format of a width B, a height H and a number of channels K which include the frequency-coded depth values TW.

The predefined number of periodic functions F is given by sine functions F or cosine functions F of a constant frequency. Each one of periodic functions F has a frequency which is defined within a predefined spectrum and differs from the frequency of the other ones of the predefined number of periodic functions F.

The depth value of each coordinate, in particular of each image pixel, of the input image is frequency coded by the algorithm using the predefined number of periodic functions. This is able to be realized pixel by pixel of a respective line of individual image E, for example.

Each one of periodic functions F stores depth values TW of individual image E in a channel K which is allocated to function F.

First image data BD1 of individual image E are coded in gray scales, in particular using one channel K per pixel for color information and one channel per pixel for depth value TW.

As an alternative, first image data BD1 of individual image E are able to be coded as an RGB color image, in particular using three channels K per pixel for the color information and one channel K per pixel for depth value TW.

Imaging sensor 10 is preferably embodied as a camera sensor. Alternatively, imaging sensor 10 is able to be embodied as a lidar sensor, a radar sensor or an ultrasonic sensor, for example.

Algorithm Al is a set of all periodic functions F. The predefined number of periodic functions F amounts to 10 to 50, in particular to 15 to 25, and to 20 functions in this particular exemplary embodiment.

FIG. 2 shows a flow diagram of the computer-implemented method for frequency coding of image data from the imaging sensor according to the preferred embodiment of the present invention.

Algorithm A1 converts frequency coded depth values TW of individual image E into a vector representation.

Second image data BD2, which are output by algorithm A1 and have frequency coded depth values TW of individual image E, are supplied as input data for the training and/or inference of an algorithm A2 of machine learning.

Algorithm A2 of machine learning preferably is an artificial neural network. Other trained algorithms suitable for the image classification, for instance, may be used as an alternative.

Algorithm A2 of machine learning may alternatively be used for a semantic segmentation, for instance, that is to say, a region-wise, in particular pixel-wise, classification. In addition, algorithm A2 of machine learning is alternatively usable for the detection, i.e., a classification, as to whether or not the object is present.

In this particular exemplary embodiment, algorithm A2 of machine learning carries out a classification KL of objects included in second image data BD2. As an alternative, algorithm A2 of machine learning is able to be used for a regression task or an image-segmentation task, for instance.

FIG. 3 shows a schematic representation of a system for frequency coding of image data from the imaging sensor according to a preferred embodiment of the present invention.

System 1 includes an imaging sensor 10, which supplies first image data BD1 of a recorded individual image, first image data BD1 having depth values of the individual image that are coded as a whole number or a floating-point number.

In addition, the system has a computing device 20, which is designed to carry out the method according to the present invention.

Computing device 20 is set up to receive first image data BD1, first image data BD1 being processed by an algorithm which is executed on computing device 20 and frequency codes the depth values of the individual image using a predefined number of periodic functions.

Computing device 20 is furthermore set up for the output of second image data by the algorithm, the second image data having frequency coded depth values of the individual image.

The present invention was described in the context of a method and system for frequency coding image data from the imaging sensor, but it is not restricted thereto.

Further alternative possible uses are the determination of a stereo depth within the framework of an indoor robotics navigation, for example.

Robot arms, for instance used for sorting objects or for automated screw-fitting and welding, act in a three-dimensional space, but often only see the 2D projection of the space as an RGB image. This does not permit decisions about free trajectories of the robot arm because the depth information gets lost in the projection. Depth images in which each pixel of the image corresponds to the distance from the object surface, on the other hand, enable decisions about the collision-free navigation or the grasping of objects.

Neural networks have the capability of generating very good depth images (regression of the distance values per pixel) from two RGB images. A partial task which the networks solve in the process is the allocation of pixel values in the two images, that is to say, which pixel in the left image and which pixel in the right image is imaging the same point of the 3D world.

Small differences such as those caused by a different illumination or reflections make the matching of pixels in both images more difficult. The standard representation in RGB therefore varies. Here, too, the frequency coding according to the present invention is helpful in that it decodes the factors of the variation in more than three channels and simultaneously standardizes them, which should allow better training of the neural network.

A further alternative application case is a 2D LIDAR as a sensor which should help the robot arm in finding the correct point for grasping the object. A neural network ascertains (classifies) the correct point for grasping the object based on the sensor data.

The LIDAR sensor supplies distance values with respect to the object surface in the form of floating-point numbers. The distance of the object represents the dominant portion in the floating-point number, surface features take up a small portion but are essential for the grasping decision, e.g., a handle of a cup that has a length of two centimeters and is situated at a distance of one meter from the sensor.

The proposed frequency coding of the depth values is helpful here in redundantly representing portions of the floating-point number corresponding to the handle and thereby making them more accessible to the neural network.

A further alternative application case is the optical inspection on the production line. In the optical inspection, RGB/depth images are analyzed or depth measurements are carried out via LIDAR. Neural networks are used for classifying, localizing or regressing errors. As a consequence, the method and system according to the present invention are able to be applied in this context as well.

FIG. 4 shows a flow diagram of a computer-implemented method for supplying an algorithm of machine learning for the classification of objects included in image data of an individual image from an imaging sensor according to the preferred embodiment of the present invention.

The method includes the receiving S1′ of image data BD2 which are output by algorithm Al according to the present invention and have frequency coded depth values TW of individual image E.

The present invention furthermore includes the receiving S2′ of a classification result allocated to an object included in a respective individual image E.

Moreover, the present method includes training S3′ of algorithm A2 of machine learning using image data BD2 and the classification result allocated to the object included in respective individual image E, the training being implemented by an optimization algorithm A3, which calculates an extreme value of a loss function.

What is claimed is:

1. A computer-implemented method for frequency coding of image data from an imaging sensor, the method comprising the following steps:
supplying first image data of an individual image recorded by the imaging sensor, the first image data having depth values of the individual image that are coded as a whole number or a floating-point number;
receiving the first image data by an algorithm which frequency codes the depth values of the individual image by a predefined number of periodic functions; and
outputting second image data by the algorithm, the second image data having frequency coded depth values of the individual image.

2. The computer-implemented method as recited in claim 1, wherein the predefined number of periodic functions is given by sine functions or cosine functions of a constant frequency, and each one of the periodic functions has a frequency that is defined within a predefined spectrum and differs from a frequency of the other ones of the predefined number of periodic functions.

3. The computer-implemented method as recited in claim 1, wherein the depth value of each image pixel of the individual image is frequency coded by the algorithm using the predefined number of periodic functions.

4. The computer-implemented method as recited in claim 1, wherein the imaging sensor is a camera sensor or a lidar sensor or a radar sensor or an ultrasonic sensor.

5. The computer-implemented method as recited in claim 1, wherein the algorithm is a set of all periodic functions, and the predefined number of periodic functions amounts to 10-50.

6. The computer-implemented method as recited in claim 5, wherein the predefine number of periodic functions amount to 15-25.

7. The computer-implemented method as recited in claim 1, wherein the algorithm converts the frequency coded depth values of the individual image into a vector representation.

8. The computer-implemented method as recited in claim 1, wherein the second image data, which are output by the algorithm and have the frequency coded depth values of the individual image, are provided as input data for training and/or an inference of an algorithm of machine learning for the classification of objects included in the image data of the imaging sensor.

9. A computer-implemented method for supplying an algorithm of machine learning for classification of objects included in image data of an individual image of an imaging sensor, the method including the steps:
supplying first image data of an individual image recorded by an imaging sensor, the first image data having depth values of the individual image that are coded as a whole number or a floating-point number;
receiving the first image data by an algorithm which frequency codes the depth values of the individual image by a predefined number of periodic functions;
outputting second image data by the algorithm, the second image data having frequency coded depth values of the individual image
receiving the second image data output by the algorithm and have frequency coded depth values of the individual image;
receiving a classification result allocated to an object included in the individual image; and
training of an algorithm of machine learning using the image data and the classification result allocated to the object included in the individual image, by an optimization algorithm, which calculates an extreme value of a loss function.

10. A system for frequency coding image data of an imaging sensor, comprising:
an imaging sensor configured to supply first image data of a recorded individual image, the first image data having depth values of the individual image coded as a whole number or as a floating-point number; and
a computing device configured to:
receive the first image data using an algorithm which frequency codes the depth values of the individual image by a predefined number of periodic functions; and
output second image data using the algorithm, the second image data having frequency coded depth values of the individual image.

11. A non-transitory computer-readable data carrier on which is stored program code of a computer program for frequency coding of image data from an imaging sensor, the program code, when executed by a computer, causing the computer to perform the following steps:
supplying first image data of an individual image recorded by the imaging sensor, the first image data having depth values of the individual image that are coded as a whole number or a floating-point number;
receiving the first image data by an algorithm which frequency codes the depth values of the individual image by a predefined number of periodic functions; and
outputting second image data by the algorithm, the second image data having frequency coded depth values of the individual image.
